(19) United States
(12) Patent Application Publication
(10) Pub. No.: US 2013/0328380 A1
(43) Pub. Date: Dec. 12, 2013

(54) Spinning Hub Cap

(71) Applicant: Lyvon J. Davis, Houston, TX (US)

(72) Inventor: Lyvon J. Davis, Houston, TX (US)

(21) Appl. No.: 13/492,919

(22) Filed: Jun. 10, 2012

(51) Int. Cl. B60B 7/00

(52) U.S. Cl. 301/37.25

(57) ABSTRACT

There is described a spinning hub cap assembly comprising: a base section connectable on its inside to the end face of the wheel center hub and on its outside to an outer section; and an outer section rotatably connected to the base section, wherein the rotatable connection permits rotation of the outer section about the wheel axis of rotation. The outer section may further comprises an outer face and an inner face, wherein the inner face further comprises a bearing mounted thereon on a bearing mount; wherein the base section outside further comprises a receiving well for receiving the bearing in mated, attached relationship. The assembly may further comprise a retention shaft employed to retain together, in rotational relationship, the outer section and the base section. In another embodiment, the base section further comprises a rotational assembly on its outside which is fixably connectable to the cap outer section.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

### FIELD OF THE INVENTION

The present invention relates generally to vehicle hubcaps or wheel center caps that spin. More particularly, the present invention relates to spinning vehicle hubcaps that are attached to the outer ends of the central hubs of wire spoke vehicle wheels, such as the 30-spoke wire wheels offered and sold by Texan Wire Wheels, LLC. (texanwirewheels.com).

BRIEF SUMMARY OF INVENTION

In one embodiment of the present invention there is described a spinning hub cap assembly, for use on the end face of a center hub of a wheel (such as, for example, a wire wheel, or a 30-spoke wire wheel), the wheel having an axis of rotation, comprising: a base section connectable on its inside to the end face of the wheel center hub and on its outside to an outer section; and an outer section rotatably connected to the base section, wherein the rotatable connection permits rotation of the outer section about the wheel axis of rotation. In another embodiment, the outer section may further comprise an outer face and an inner face, wherein the inner face further comprises a bearing (such as a sealed bearing) mounted thereon on a bearing mount; wherein the base section outside further comprises a receiving well for receiving the bearing in mated, attached relationship. The assembly may further comprise a retention shaft employed to retain together, in rotational relationship, the outer section and the base section. In another embodiment, the base section further comprises a rotational assembly on its outside which is fixably connectable to the cap outer section. The outer section may comprise a central section, and two or more spaced-apart winged sections. The outer section may also comprise a central section, and two opposed winged sections.

### BRIEF DESCRIPTION OF THE SEVERAL VIEWS OF THE DRAWINGS

FIG. 1A presents a perspective view of a 30-spoke prior art wire wheel offered and sold by Texan Wire Wheels, LLC (texanwirewheels.com) containing a fixed, non-spinning hub cap, here shown with a 2-bar variety fixed (non-spinning) wheel center cap.

FIG. 1B presents a side view of a 30-spoke prior art wire wheel offered and sold by Texan Wire Wheels, LLC (texanwirewheels.com) containing a fixed, non-spinning hub cap, here shown with a 2-bar variety fixed (non-spinning) wheel center cap.

FIG. 1C presents a perspective, topside view of a prior art wire wheel center cap offered and sold by Texan Wire Wheels, LLC (texanwirewheels.com) (here, shown in the hexagonal shape) for attaching in a fixed, non-spinning relationship to the center hub extension of the wheel.

FIG. 1D presents a perspective, underside view of a prior art wire wheel center cap offered and sold by Texan Wire Wheels, LLC (texanwirewheels.com) (here, shown in the hexagonal shape) for attaching in a fixed, non-spinning relationship to the center hub extension of the wheel via the threaded post connection shown or other suitable attachment configuration. The hexagonal hub is shown resting on the wheel center hub end face.

FIG. 1E presents a perspective, topside view of a prior art wire wheel center cap offered and sold by Texan Wire Wheels, LLC (texanwirewheels.com) (here, shown in the 2-bar shape) for attaching in a fixed, non-spinning relationship to the center hub extension of the wheel.

FIG. 2 shows topside view of a spinning wheel center cap according to the present invention (here, shown in the 2-bar or wing shape, but other cap shapes are possible) for attaching to the center hub extension of the wheel in a manner that permits the outer portion of the cap to rotate freely relative to the wheel center hub.

FIG. 3A shows an underside perspective view of the spinning wheel center cap of FIG. 2 according to the present invention (here, shown in the 2-bar or wing shape, but other cap shapes are possible). The upper section of the cap is mounted to the lower section in a rotatable, spinnable relationship. The lower base section is fixably mounted to the center hub extension of the wheel via the threaded post connection shown or via other suitable attachment configuration.

FIG. 3B shows an underside perspective view of the spinning wheel center cap of FIG. 2 according to the present invention (here, shown in the 2-bar or wing shape, but other cap shapes are possible). The upper section of the cap is mounted to the lower section in a rotatable, spinnable relationship. The lower base section is fixably mounted to the center hub extension of the wheel via the threaded post connection shown or via other suitable attachment configuration.

FIG. 3C shows a side view close up of the spinning wheel center cap of FIG. 2 according to the present invention (here, shown in the 2-bar or wing shape, but other cap shapes are possible) for attaching in a rotatable, spinning relationship to the center hub extension of the wheel. The upper section of the cap is mounted to the lower section in a rotatable, spinnable relationship. The lower base section is fixably mounted to the center hub extension of the wheel via suitable attachment configuration.

FIG. 3D shows a side view of the spinning wheel center cap of FIG. 2 according to the present invention (here, shown in the 2-bar or wing shape, but other cap shapes are possible) for attaching in a rotatable, spinning relationship to the center hub extension of the wheel. The upper section of the cap is mounted to the lower section in a rotatable, spinnable relationship. The lower base section is fixably mounted to the center hub extension of the wheel via suitable attachment configuration.

FIG. 4A shows an underside view of the spinning wheel center cap of FIG. 2 according to the present invention (here, shown in the 2-bar or wing shape, but other cap shapes are possible). The underside of the lower or base section can be fixably attached to the center hub extension of the wheel via the threaded post connection on the connection member shown or other suitable attachment configuration. The connection member shown is mounted in a recessed fashion and secured with screws or other suitable securing mechanisms.

FIG. 4B shows a perspective underside view of the spinning wheel center cap of FIG. 4A according to the present invention. The underside of the lower or base section can be fixably attached to the center hub extension of the wheel via the threaded post connection member (shown partially removed and in topside perspective view) or via other suitable attachment configuration.

FIG. 4C shows a perspective underside view of the spinning wheel center cap of FIG. 4A according to the present invention. The underside of the lower or base section can be fixably attached to the center hub extension of the wheel via the threaded post connection member insert (shown removed from the recessed well and in underside perspective view) or via other suitable attachment configuration.

FIG. 4D shows an underside view of the spinning wheel center cap of FIG. 4A according to the present invention. The underside of the lower or base section can be fixably attached to the center hub extension of the wheel via the threaded post connection member (not shown, removed from the recessed well) or via other suitable attachment configuration. A recessed well for receiving the connection member is shown.

FIG. 4E shows a close up underside view of the spinning wheel center cap of FIG. 4D according to the present invention showing a securing bolt in the connection member recessed well.

FIG. 4F shows a perspective underside view of the spinning wheel center cap of FIGS. 4D and 4E according to the present invention showing the securing bolt partially removed.

FIG. 4G shows a close up underside view of the spinning wheel center cap of FIGS. 4D-F according to the present invention showing the securing bolt partially removed.

FIG. 4H shows a close up underside view of the spinning wheel center cap of FIG. 4G according to the present invention showing the securing bolt or retaining shaft removed.

FIG. 4I shows a close up underside view of the spinning wheel center cap of FIG. 4H according to the present invention showing the threaded post in the base for receiving the securing bolt, and showing the threaded apertures for receiving the screws that secure the connection member insert.

FIG. 4J shows a close up of the receiving well of FIG. 4I.

FIG. 4K shows another close up of the receiving well of FIG. 4I.

FIG. 5A shows a side view of the spinning wheel center cap of FIG. 4H according to the present invention wherein the upper section is shown partially removed from the lower base section.

FIG. 5B shows a perspective view of the upper section (on left) and the lower base section (on right) separated from each other. The upper section is shown in an underside perspective view and shows a sealed bearing mounted on a threaded post. The base section is shown in topside perspective to illustrate how the top and bottom sections fit together in mated fashion with the securing bolt.

FIG. 5C shows a perspective view of the upper section (on left) and the lower base section (on right) separated from each other. The upper section is shown in an underside perspective view and shows a sealed bearing mounted on a threaded post. The base section is shown in topside perspective to illustrate how the top and bottom sections fit together in mated fashion with the securing bolt (not shown).

FIG. 6A shows an underside view of the top section of the spinning wheel center cap of FIG. 2 according to the present invention.

FIG. 6B shows an underside perspective view of the top section of the spinning wheel center cap of FIG. 2 according to the present invention.

FIG. 6C shows an underside close up perspective view of the top section of the spinning wheel center cap of FIG. 2 according to the present invention.

FIG. 6D shows another underside perspective view of the top section of the spinning wheel center cap of FIG. 2 according to the present invention.

FIG. 6E shows another underside close up perspective view of the top section of the spinning wheel center cap of FIG. 2 according to the present invention showing here, for illustration purposes (and without the base in place), how the securing bolt secures to the threaded post.

FIG. 7A shows a topside perspective view of the bottom (base) section of the spinning wheel center cap of FIG. 2 according to the present invention.

FIG. 7B shows a side view of the bottom (base) section of the spinning wheel center cap of FIG. 7A according to the present invention.

FIG. 7C shows a topside view of the bottom (base) section of the spinning wheel center cap of FIG. 7A according to the present invention.

FIG. 7D shows an underside view of the bottom (base) section of the spinning wheel center cap of FIG. 7A according to the present invention.

FIG. 7E shows an underside perspective view of the bottom (base) section of the spinning wheel center cap of FIG. 7A according to the present invention.

FIG. 7F shows a side view of the bottom (base) section of the spinning wheel center cap of FIG. 7A according to the present invention where the base contains the hub connection insert shown without the top section in place.

FIG. 7G shows an underside perspective view of the bottom (base) section of the spinning wheel center cap of FIG. 7F according to the present invention where the base contains the hub connection insert shown without the top section in place.

FIG. 8A shows a topside view of the connection member insert of the bottom (base) section of the spinning wheel center cap of FIG. 2 according to the present invention.

FIG. 8B shows an underside view of the connection member insert of the bottom (base) section of the spinning wheel center cap of FIG. 2 according to the present invention.

FIG. 8C shows a side view of the connection member insert of the bottom (base) section of the spinning wheel center cap of FIG. 2 according to the present invention.

FIG. 9A shows a side view of the securing bolt (retaining shaft) of the spinning wheel center cap of FIG. 2 according to the present invention.

FIG. 9B shows a top view of the securing bolt of the spinning wheel center cap of FIG. 2 according to the present invention.

FIG. 9C shows an underside perspective view of the securing bolt of the spinning wheel center cap of FIG. 2 according to the present invention.

FIG. 9D shows another side view of the securing bolt of the spinning wheel center cap of FIG. 2 according to the present invention.

FIG. 10A shows an exploded view of the spinning wheel center cap of FIG. 2 according to the present invention.

FIG. 10B shows another exploded view of the spinning wheel center cap of FIG. 2 according to the present invention.

FIG. 10C shows another exploded view of the spinning wheel center cap of FIG. 2 according to the present invention.

### DETAILED DESCRIPTION OF THE INVENTION

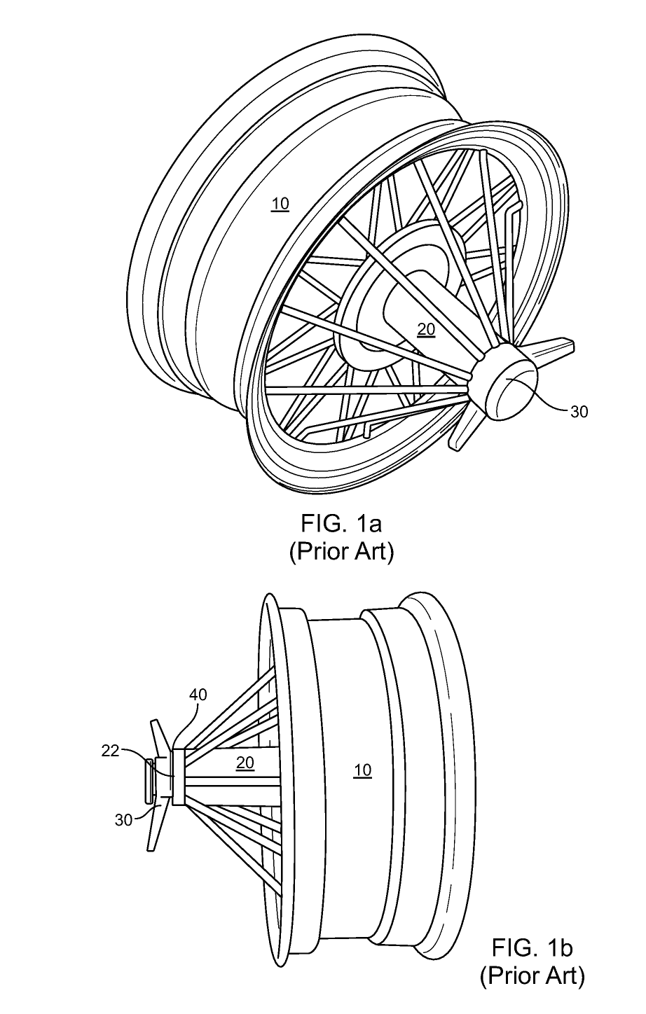

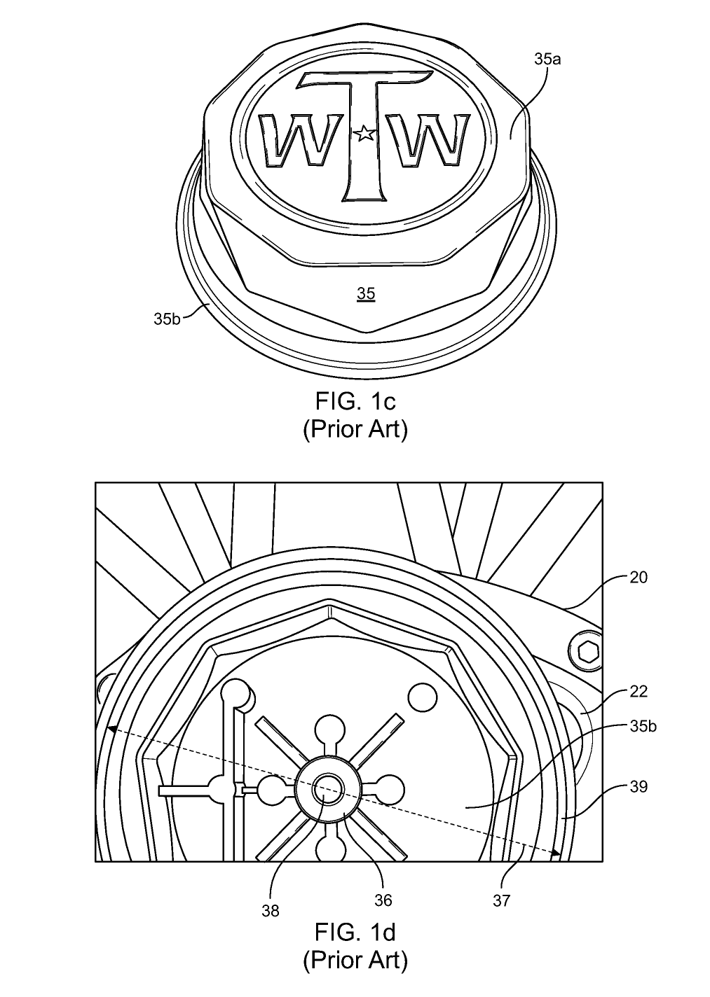

Referring to FIGS. 1A-1B, there is shown an exemplary 30-spoke prior art wire wheel 10 offered and sold by Texan Wire Wheels, LLC (texanwirewheels.com) containing a fixed, non-spinning hub cap, here shown with a 2-bar variety fixed (non-spinning) wheel center cap 30. The fixed hub cap is mounted to the end face 22 of the wheel center hub 20.

FIG. 1C presents a perspective, topside 35a view of a prior art wire wheel center cap offered and sold by Texan Wire Wheels, LLC (texanwirewheels.com) (here, shown in the hexagonal shape) 35 for attaching in a fixed, non-spinning relationship to the end face 22 of the center hub extension 20 of the wheel 10. FIG. 1D presents a perspective, underside 35b view of a prior art wire wheel center cap offered and sold by Texan Wire Wheels, LLC (texanwirewheels.com) (here, shown in the hexagonal shape) 35 for attaching in a fixed, non-spinning relationship to the end face 22 of the center hub extension 22 of the wheel 10 via the post connection 36 shown (with threaded aperture 38) or other suitable attachment configuration. The hexagonal hub cap 34 is shown resting on the wheel center hub 20 end face 22. These fixed caps 35, have an underside lip 39 spanning a diameter 36 that permits the cap to fit over the outer diameter of the wheel center hub end face 22 to facilitate a clean, mated point of connection 40 between the fixed hub cap 30 and the wheel center hub 20 end face 22.

FIG. 1E presents a perspective, topside view of a prior art wire wheel center cap offered and sold by Texan Wire Wheels, LLC (texanwirewheels.com) (here, shown in the 2-bar shape) 30 for attaching in a fixed, non-spinning relationship to the face 22 of the center hub extension 20 of the wheel 10. This two-bar or winged cap has an outer side 110, and underside 120, and two or more wings or bars 32. Many different configurations are available, the 2-bar variety and the hex cap variety are being shown here for illustration purposes.

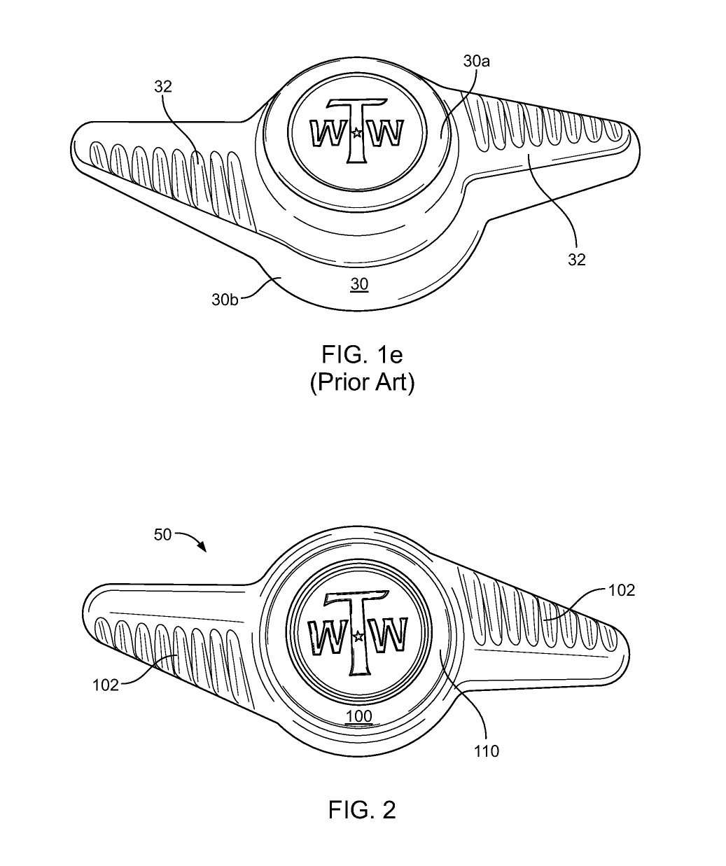

FIG. 2 shows topside view of a spinning wheel center cap 50 according to the present invention (here, shown in the 2-bar or wing shape, but other cap shapes are possible) for attaching to the end face 22 of the center hub extension 20 of the wheel 10 in a manner that permits the outer or top portion 100 of the cap to rotate freely relative to the wheel center hub 20. In this 2-bar variety spinning center cap 50, the cap upper spinning section 100 may comprise wings 102. In a preferred embodiment, the cap 50 comprises two opposed wings 102 that have aerodynamically designed edges to permit wind friction to cause the cap spinning section 100 to rotate. The cap upper (spinning) section 100 has an outer side 110 that may contain decorative elements visible when looking at the cap 50 mounted on the wheel 10. The cap upper section 100 also has an underside 120.

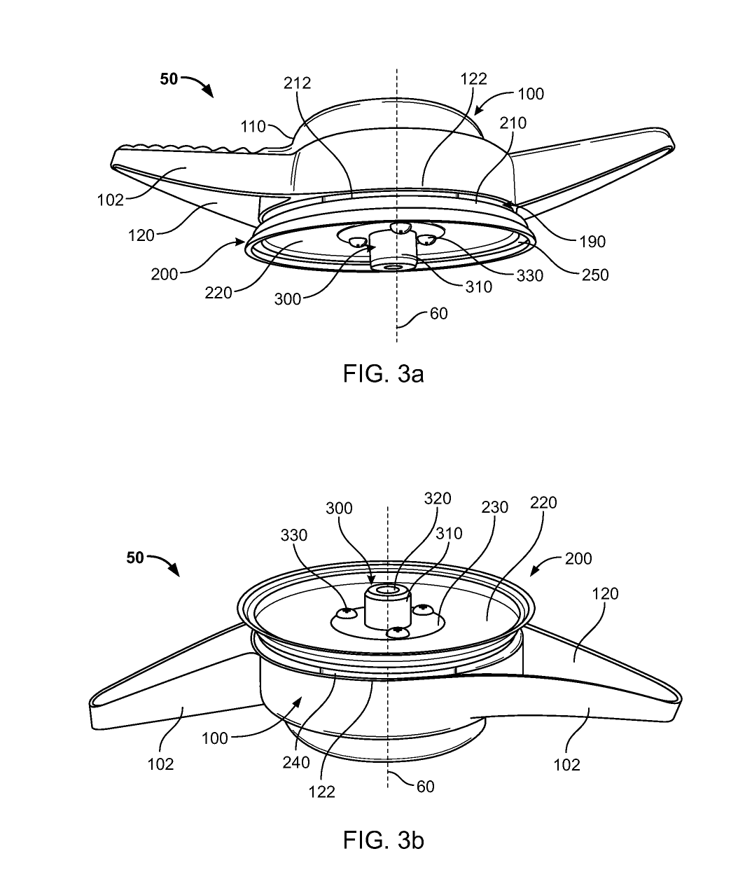

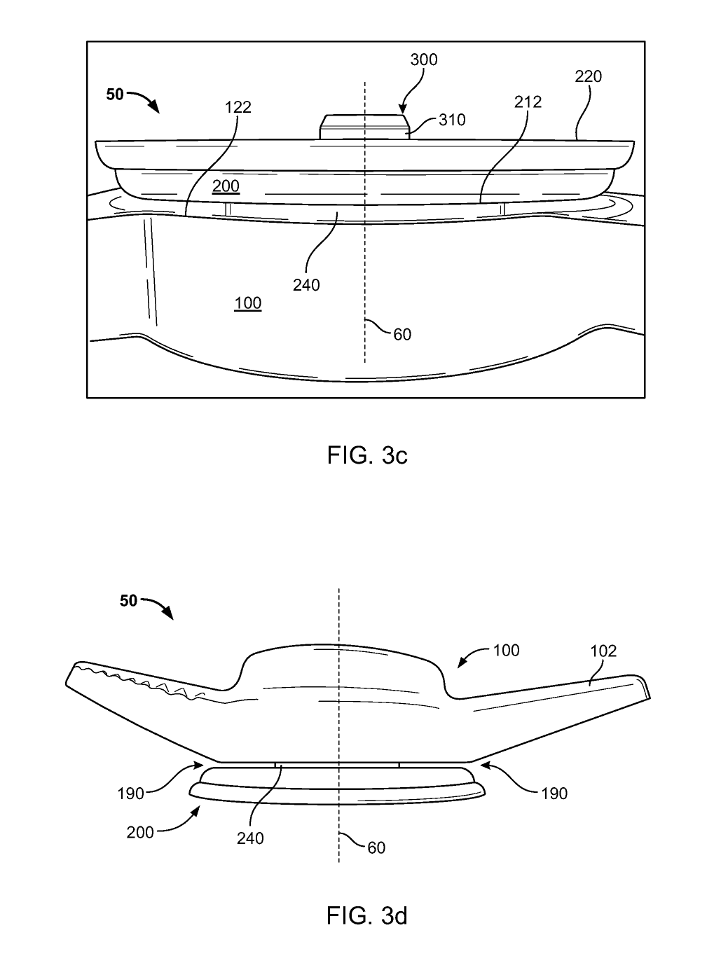

Referring also to FIGS. 3A-3D, there is shown various views of the spinning wheel center cap 50 of FIG. 2. The upper section 100 of the cap 50 is mounted to the lower section 200 in a rotatable, spinnable relationship. The lower base section 200 is fixably mounted to the face 22 of the center hub extension 20 (not shown) of the wheel 10 (not shown) via the threaded post 310 of connection insert 300 shown or via other suitable attachment configuration. In a preferred embodiment, the lower base 200 comprises a lip 250 that fits snugly over the outer diameter of the end face 22 of the wheel center hub 20. In this embodiment, the base is fitted with an insert connection 300 that is secured in place via screws 330 to the underside 220 of the base 200. The insert connection 300 comprises a connection post 310 of desired height, and preferably includes threaded aperture 320 for receiving a connection bolt (not shown) used to secure the cap 50 to the wheel center hub end face 22. The upper section 100 is permitted to rotate about the lower section 200 along axis of rotation 60. The upper section 100 of the cap 50 is mounted to the lower section 200 in a rotatable, spinnable relationship in a manner that creates a gap 190 separating the lower edges 122 of the upper section 100 from the upper edges 212 of the base section 200. The cap lower or base section 200 comprises a topside 210 and an underside 220.

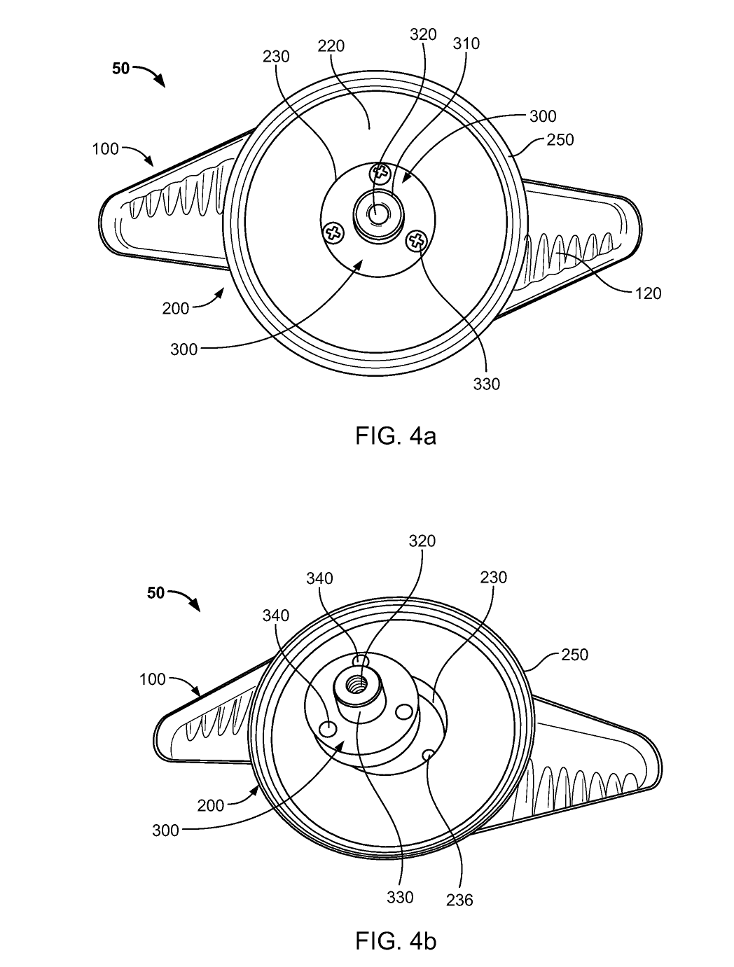

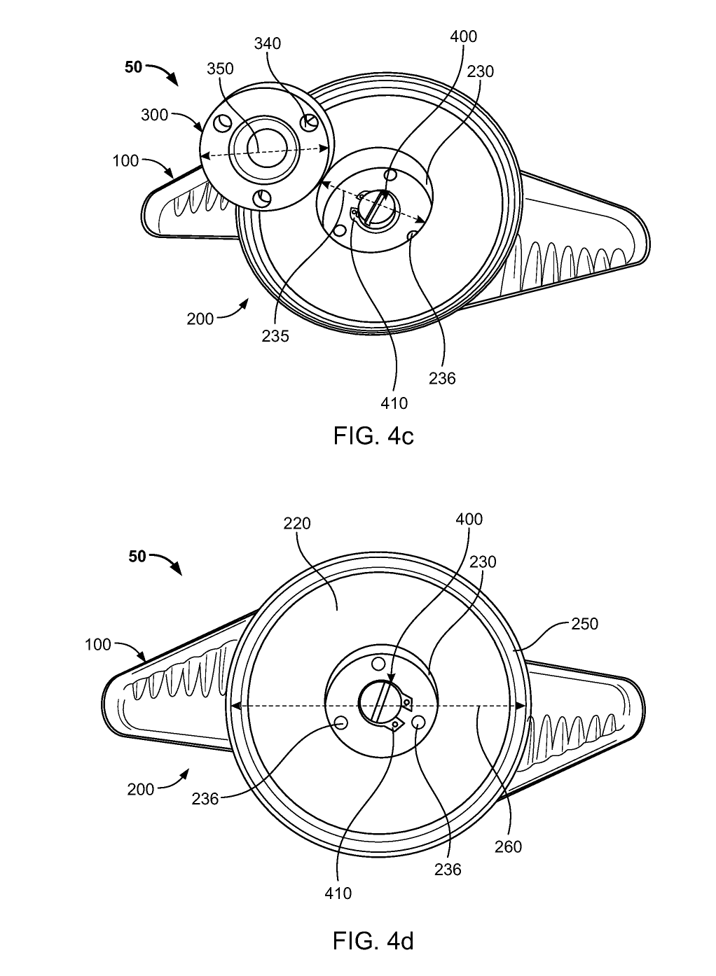

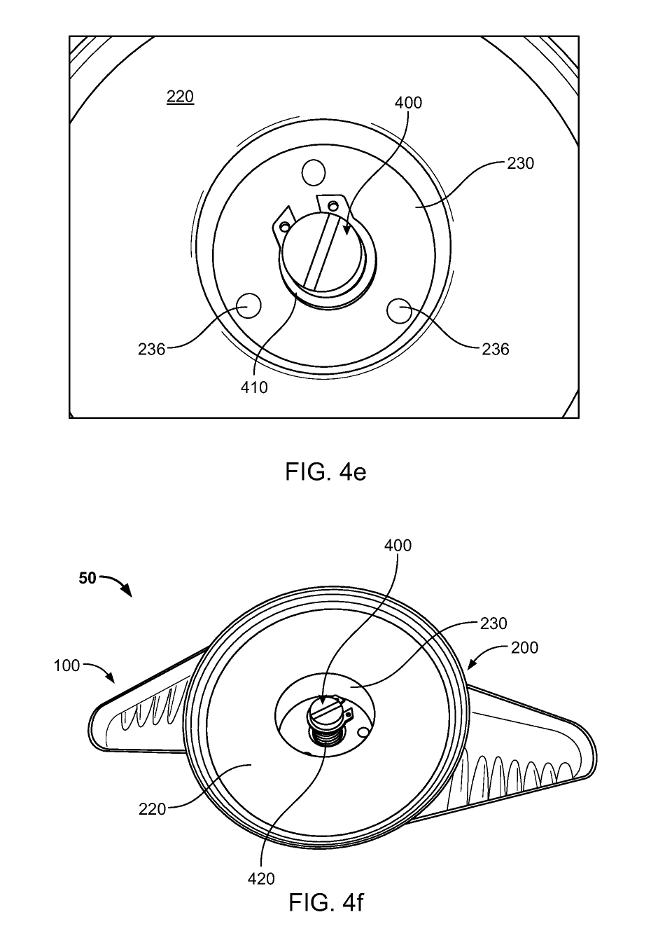

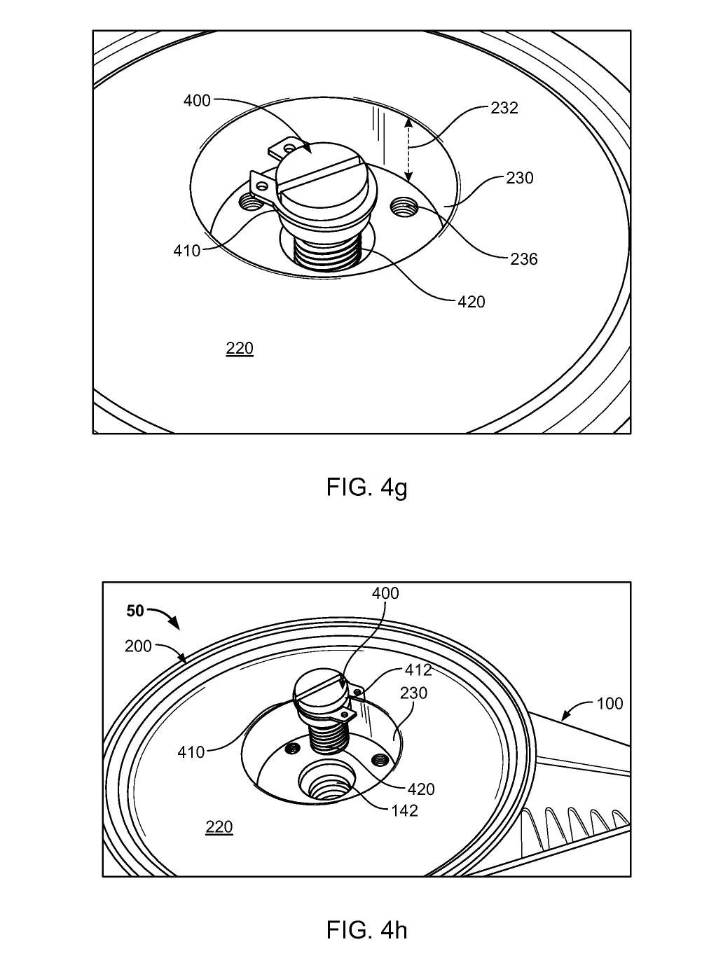

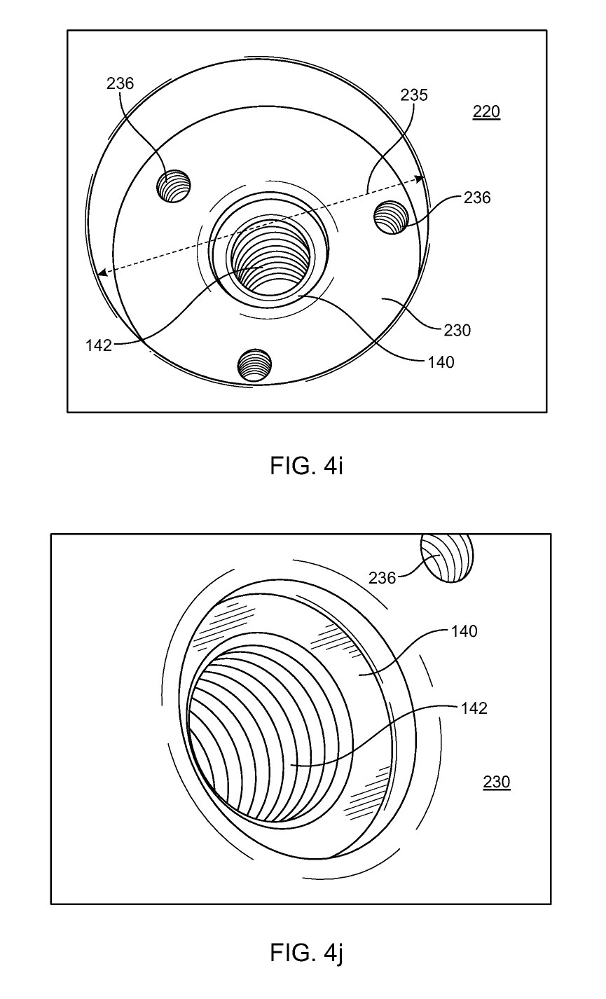

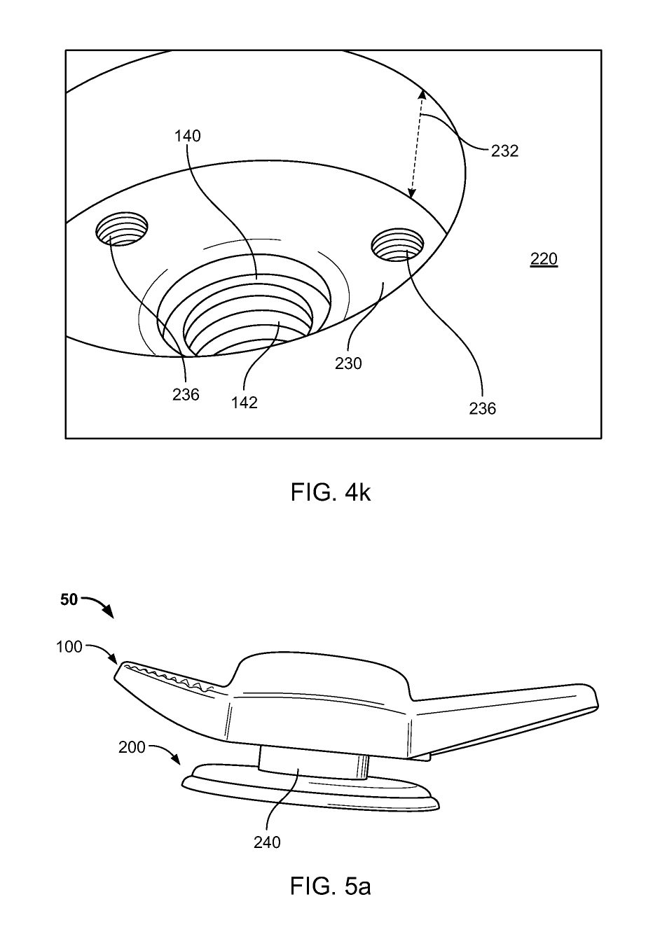

FIG. 4A shows an underside view of the spinning wheel center cap 50 of FIG. 2. The underside 220 of the lower or base section 200 can be fixably attached to the face 22 of center hub extension of the wheel (not shown) via the threaded post connection 310 on the connection member 300 shown or via other suitable attachment configuration. The connection member 300 shown is mounted in a recessed fashion within base insert well 230 and secured with screws 330 or other suitable securing mechanisms. FIG. 4B shows a perspective underside view of the spinning wheel center cap 50 of FIG. 4A. The threaded post connection member 300 is shown partially removed and in topside perspective view. The connection insert 300 sits within receiving well 230 and is secured in place, for example, by screws 330 that are passed through the hub insert attachment apertures 340 and secured into the base insert well threaded apertures 236.

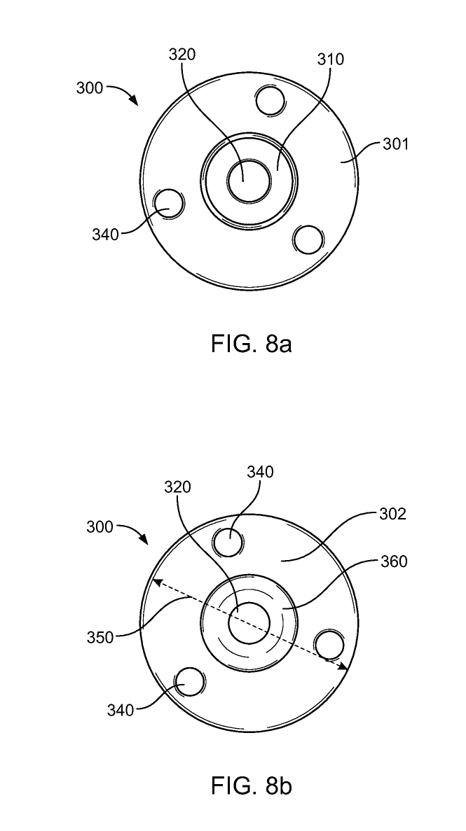

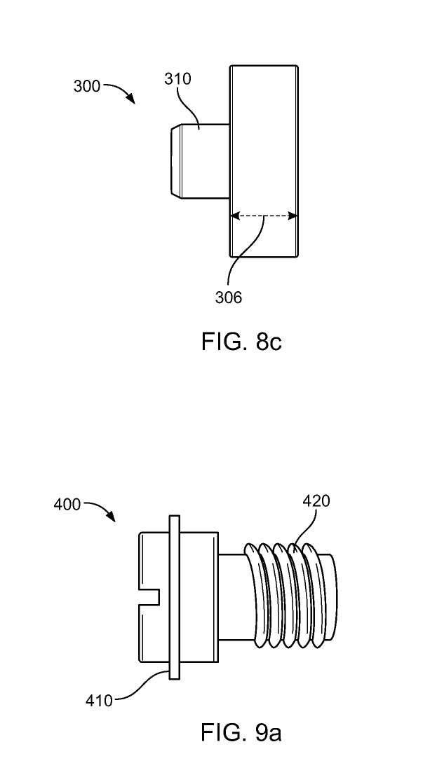

Referring also to FIGS. 4C-4K, the base insert receiving well 230 has a diameter 235 that is adapted to receive the hub connection insert 300 having an outer diameter 350. The connection member insert 300 is shown fully removed from the recessed well 230 and in underside perspective view. A retaining shaft 400 with external retaining ring 410 mounted in retaining ring groove 412 is employed to secure the cap upper section 100 to the cap lower section 200 in a manner that permits rotation of the upper section 100 about the axis 60 relative to the lower section 200. In a preferred embodiment, the lower base 200 comprises a lip 250 having a diameter 260 that fits snugly over the outer diameter of the end face 22 of the wheel center hub 20. FIGS. 4F-4G show the securing bolt or retaining shaft 400 partially removed. The securing bolt or retaining shaft 400 employs threads 420 that are mated to be received in the threaded aperture 142 in the bearing mount post 140 located in the center of the cap spinning section underside 120 (shown in later figures). FIG. 4H shows the securing bolt or retaining shaft 400 removed to reveal the threaded aperture 142. The receiving well 230 has a depth 232 that in one preferred embodiment matches the height 306 of the insert 300 (see FIG. 8C).

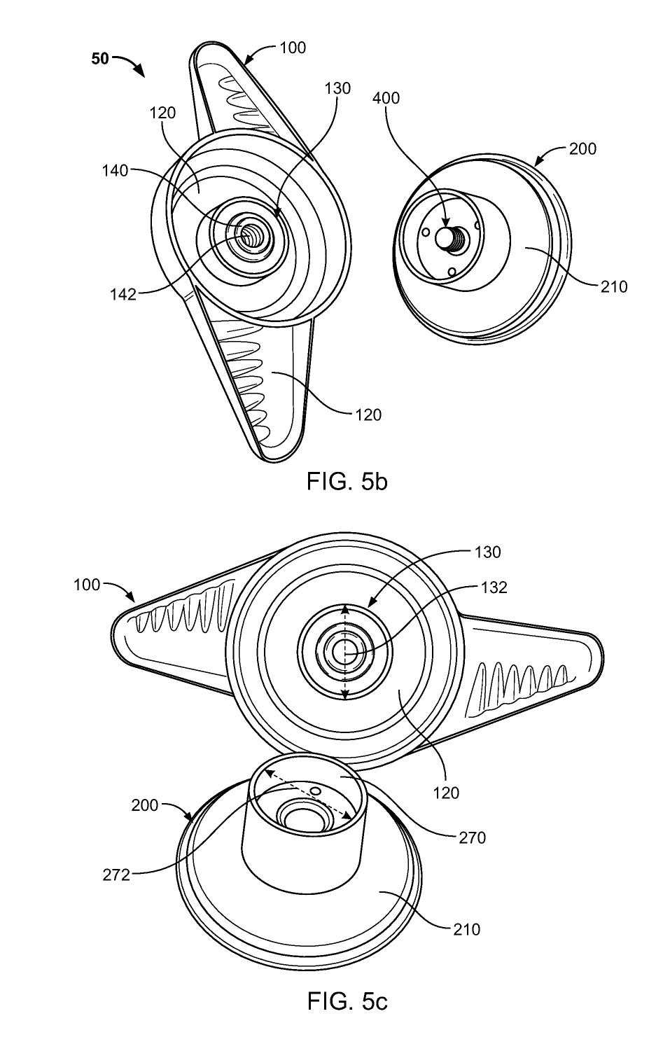

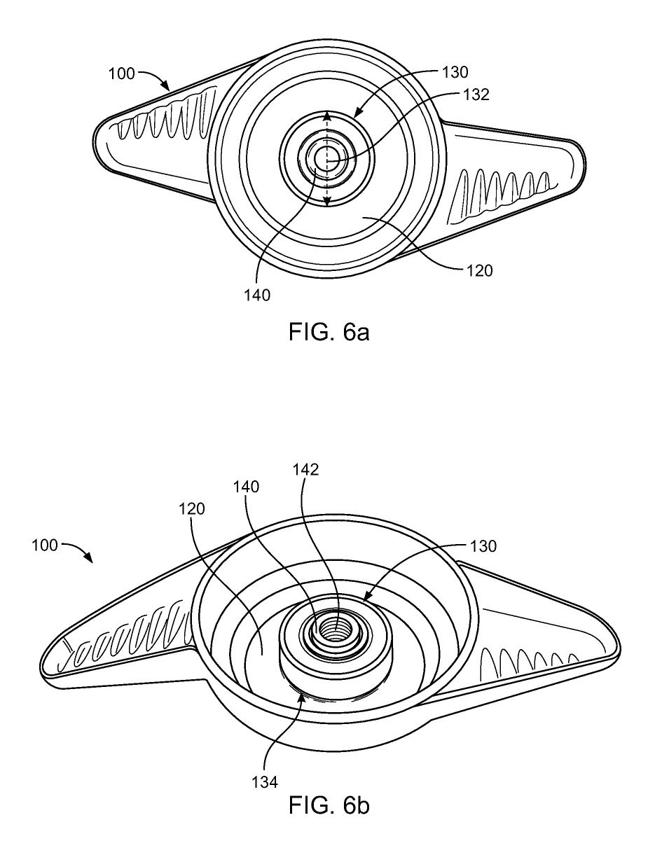

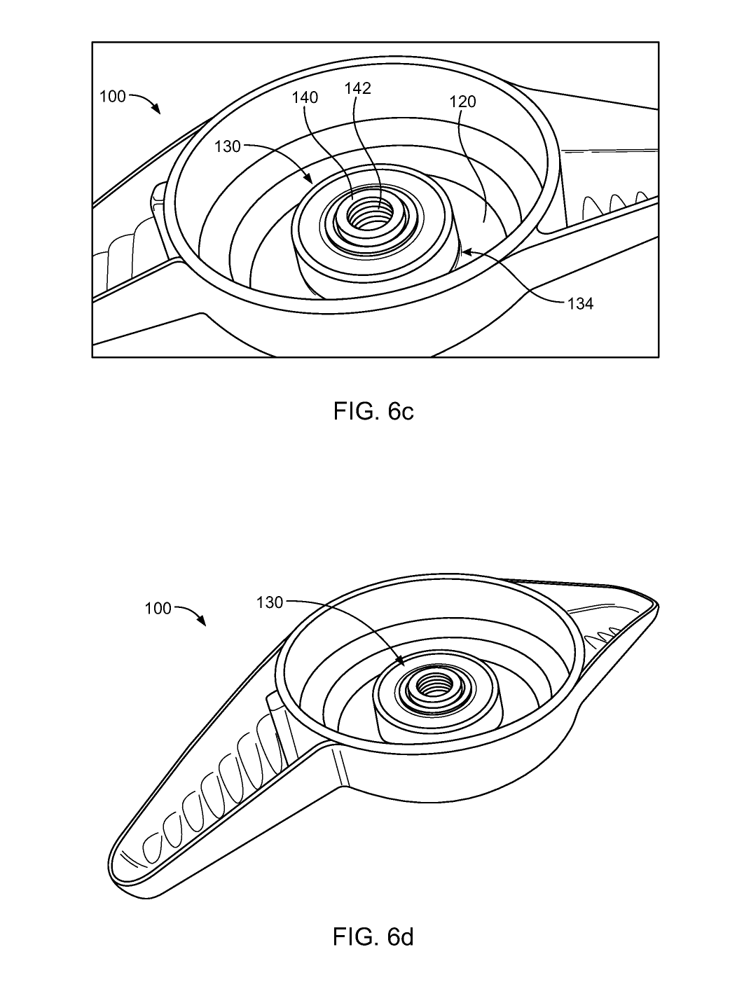

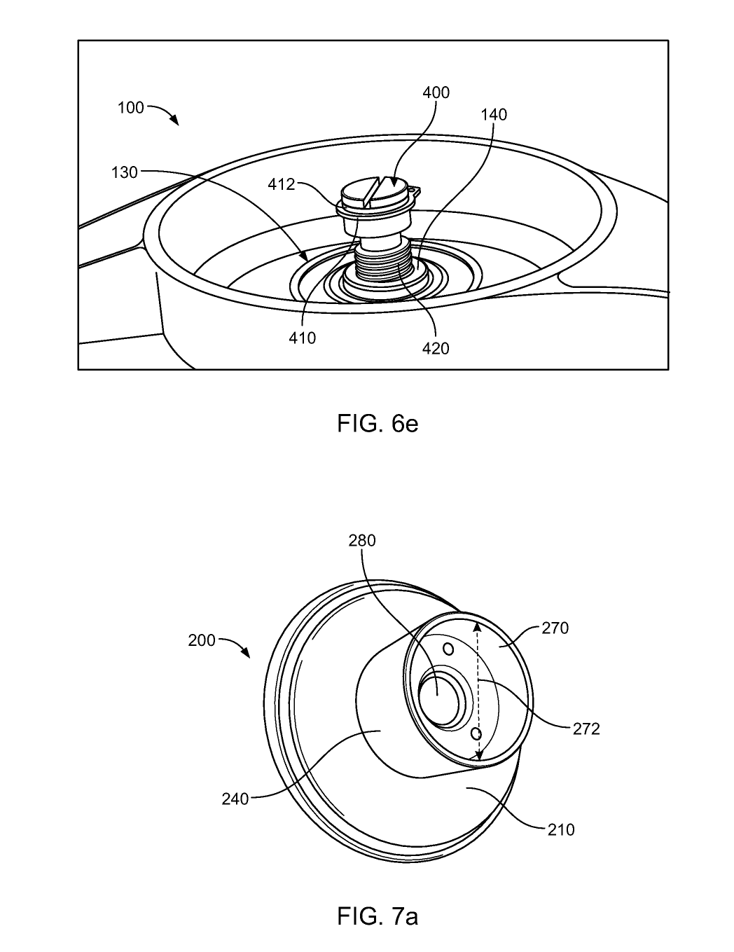

FIG. 5A shows a side view of the spinning wheel center cap of FIG. 4H according to the present invention wherein the upper section is shown partially removed from the lower base section. FIGS. 5B-5C show the upper section 100 and the lower base section 200 separated from each other. Referring also to FIGS. 6A-E, the upper section 100 has a sealed bearing 130 fixably mounted on bearing mount post 140 in a manner that permits free rotational movement of the bearing 130 (i.e., there is a gap 134 between bearing 130 and cap spinning section underside 120). The bearing can freely rotate about the bearing mount post about axis 60. The bearing 130 is preferably a sealed bearing such as the rubber sealed variety sold by VXB.com under the model number 6202RS (15×35×11 mm) or the like. Other suitable bearing configurations known in the art may be employed. The upper side 210 of the base section 200 is configured with a base extension stem 240 of desired height. Within the base extension stem 240 is a bearing receiving well 270 having in inside diameter 272 capable of receiving in snug relationship the outside diameter 132 of bearing 130 so as to permit the cap upper section 100 to be secured to bearing 130 to permit the upper section 100 to rotate on the bearing 130 about axis 60. The top 100 and bottom 200 sections fit together in mated fashion with the bearing 130 being received into the bearing receiving well 270, and securing bolt or retaining shaft 400 being used to retain the top 100 and base 200 sections together. The securing bolt 400 fits through base retaining shaft aperture 280.

FIG. 6E shows another underside close up perspective view of the top section of the spinning wheel center cap of FIG. 2 according to the present invention showing here, for illustration purposes (and without the base in place), how the securing bolt 400 secures via its threads 420 to the bearing mount post 140 threaded aperture 142.

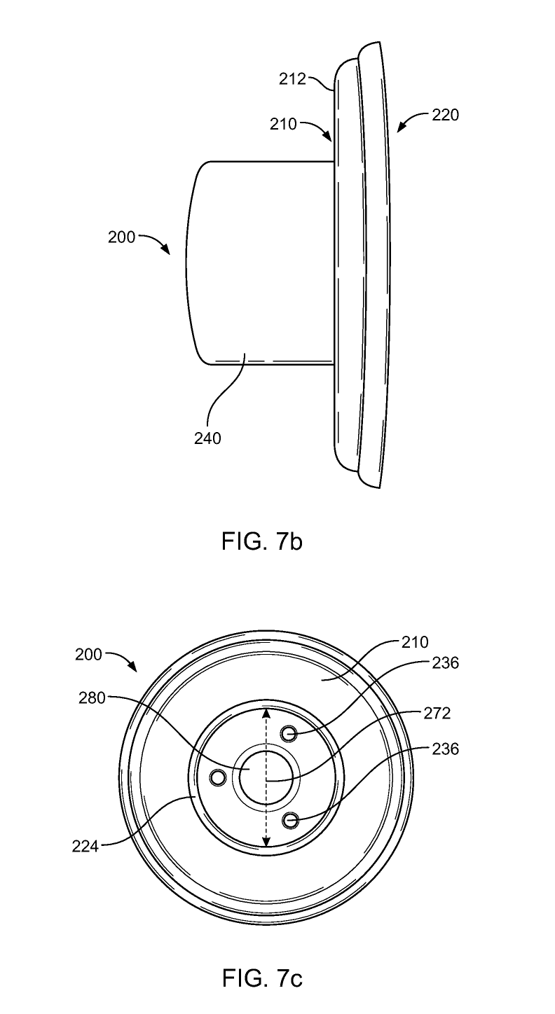

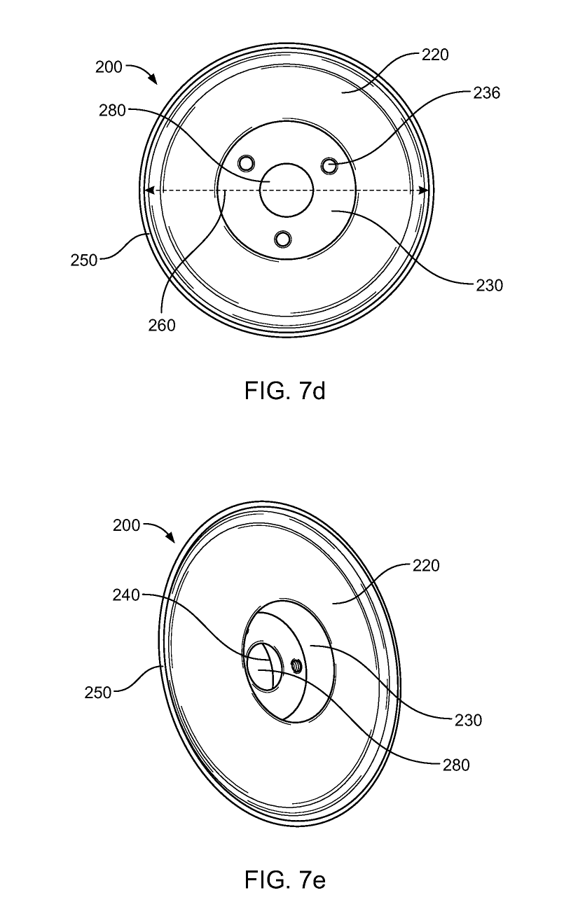

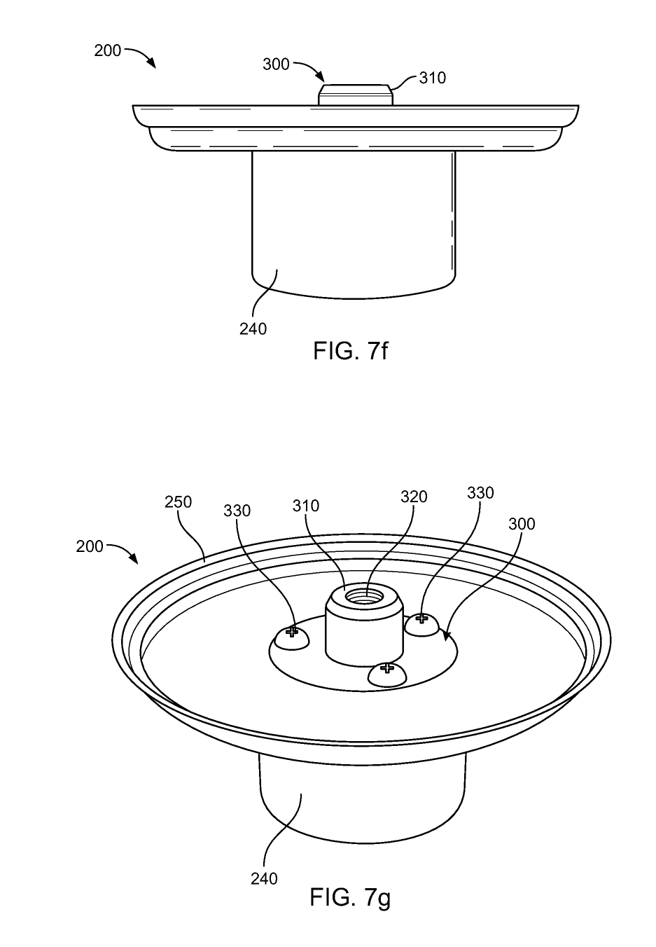

FIGS. 7A-7G show various views of the bottom (base) section 200 of the spinning wheel center cap 50 of FIG. 2 according to the present invention. FIGS. 7F-7G illustrate the mounted relationship of hub connection insert 300 with its connection post 310 shown (for illustration purposes) without the top section 100 in place.

FIGS. 8A-8C shows various views of the connection member insert 300 of the bottom (base) section 200 of the spinning wheel center cap 50 of FIG. 2 according to the present invention. The insert 300 has a topside 301 and a bottom side 302. On the bottom side is located an insert underside well to permit clearance for the top of retaining shaft 400.

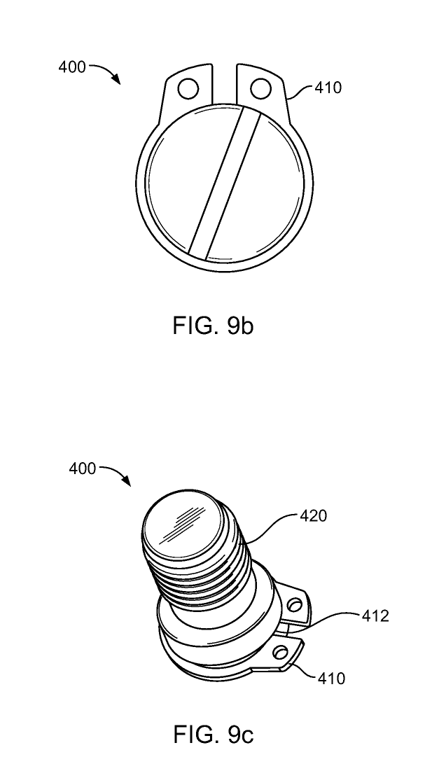

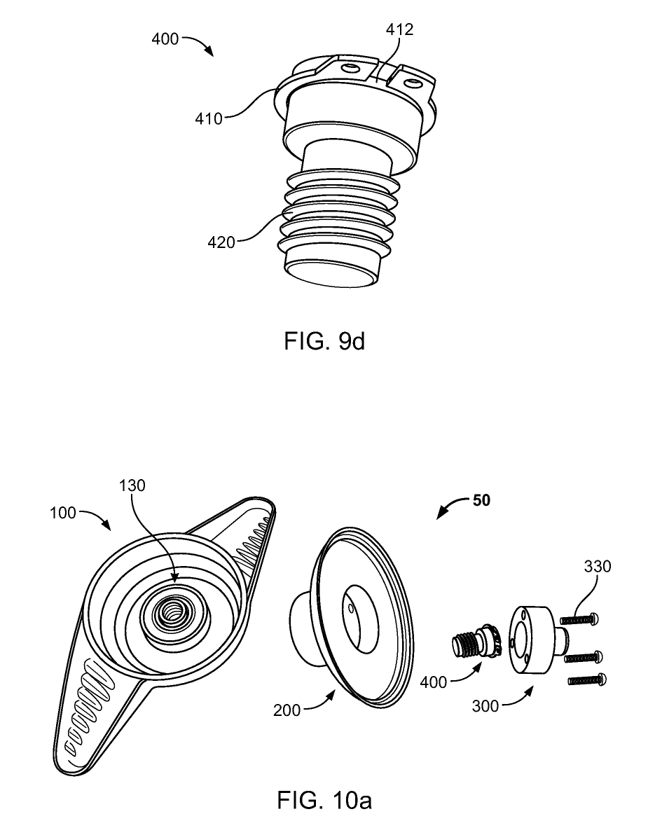

FIGS. 9A-9C illustrate various views of a preferred securing bolt (retaining shaft) 400. The bolt 400 is outfitted with a retaining ring groove 412 to receive an external retaining ring 410 such as those made by Rotor Clip Company (www.rotorclip.com) of the spinning wheel center cap of FIG. 2 according to the present invention. Other suitable retaining shaft configurations may be employed.

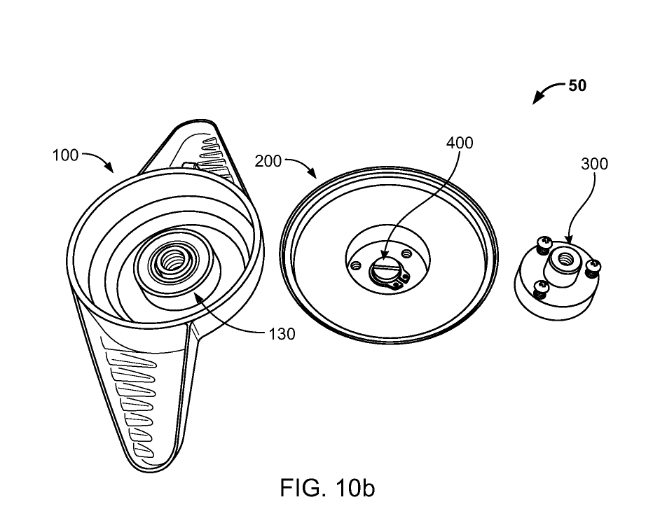

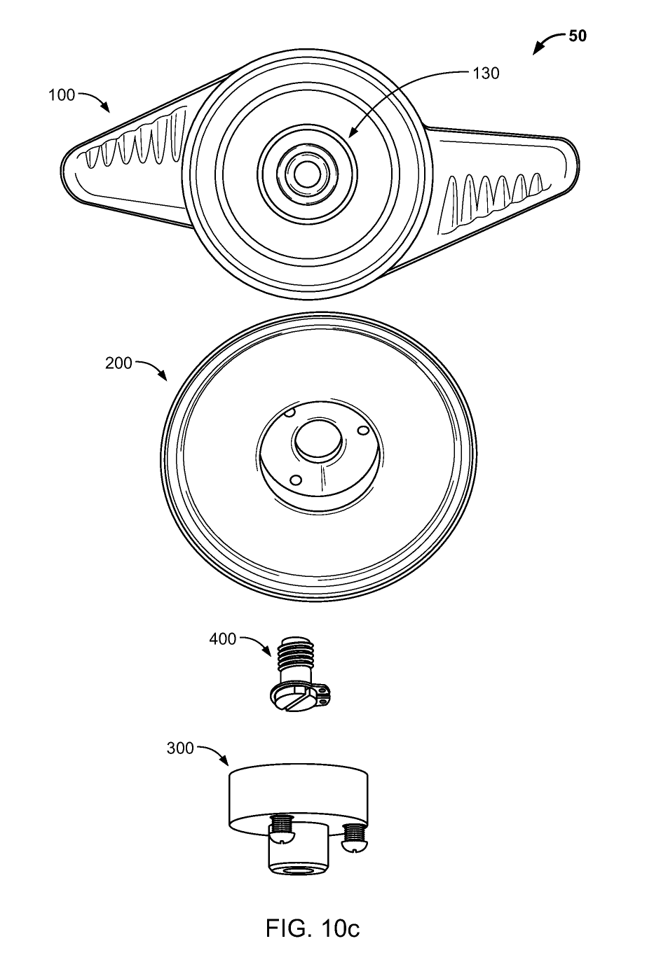

FIGS. 10A-10C shows an exploded view of the spinning wheel center cap of FIG. 2 according to the present invention. As will be understood from the above descriptions of a preferred embodiment, the spinning cap outer section 100 is outfitted with a bearing 130. The bearing 130 is then mounted in fixed position within the base 200 to permit the upper section 100 to freely rotate (via bearing 130) about axis 60 relative to the base 200. The retainer shaft or other suitable mechanism is employed to retain the upper 100 and lower 200 sections together while also permitting the upper section 100 to freely rotate. The retainer shaft is mounted within the base, and the connection insert 300 is then mounted over the retainer 400. The cap 50 may then be attached, via attachment post 310 or via other suitable attachment configuration, to the wheel center hub end face 22 of a desired wheel.

The various components of the above-described spinning cap 50 invention may be manufactured out of materials known in the art for these purposes, such as, metals, plastics, composite materials, and the like, and combinations thereof. The various fastening mechanisms may be varied, and one of ordinary skill in the art, having the benefit of the present disclosure, would be able to engineer other suitable embodiments within the spirit and scope of the present invention and its pending claims. Additionally, although the present disclosure describes the use of a bearing that is mounted on the inside of the outer section 100, one of ordinary skill in the art with the benefit of the present disclosure could mount the bearing assembly in other suitable locations on the device, or in connection with the attachment of the outer section 100 to the wheel hub face 22.

All references referred to herein are incorporated herein by reference. While the apparatus, systems and methods of this invention have been described in terms of preferred or illustrative embodiments, it will be apparent to those of skill in the art that variations may be applied to the process and system described herein without departing from the concept and scope of the invention. All such similar substitutes and modifications apparent to those skilled in the art are deemed to be within the scope and concept of the invention. Those skilled in the art will recognize that the method and apparatus of the present invention has many applications, and that the present invention is not limited to the representative examples disclosed herein. Moreover, the scope of the present invention covers conventionally known variations and modifications to the system components described herein, as would be known by those skilled in the art.

I claim:

1. A spinning hub cap assembly, for use on the end face of a center hub of a wheel, the wheel having an axis of rotation, comprising:
a. a base section connectable on its inside to the end face of the wheel center hub and on its outside to an outer section; and
b. an outer section rotatably connected to the base section, wherein the rotatable connection permits rotation of the outer section about the wheel axis of rotation.

2. The spinning hub cap assembly of claim 1 wherein the outer section is rotatably connected to the base section via a bearing.

3. The spinning hub cap assembly of claim 2 wherein the bearing is a sealed bearing.

4. The spinning hub cap assembly of claim 1 further comprising:
wherein the outer section further comprises an outer face and an inner face, wherein the inner face further comprises a bearing mounted thereon on a bearing mount;
wherein the base section outside further comprises a receiving well for receiving the bearing in mated, attached relationship.

5. The spinning hub cap assembly of claim 4 further comprising a retention shaft employed to retain together, in rotational relationship, the outer section and the base section.

6. The spinning hub cap assembly of claim 1 wherein the base section further comprises a rotational assembly on its outside which is fixably connectable to the cap outer section.

7. The spinning hub cap assembly of claim 1 wherein the outer section comprises a central section, and two or more spaced-apart winged sections.

8. The spinning hub cap assembly of claim 1 wherein the outer section comprises a central section, and two opposed winged sections.

9. The spinning hub cap assembly of claim 1 wherein the wheel is a wire wheel.

10. The spinning hub cap assembly of claim 9 wherein the wheel is a 30-spoke wire wheel.
